(19) United States
(12) Patent Application Publication
(10) Pub. No.: US 2025/0130349 A1
(43) Pub. Date: Apr. 24, 2025

(54) DOMAIN GENERALIZATION FOR CROSS-DOMAIN RAIN INTENSITY DETECTION BASED ON DISTRIBUTED FIBER OPTIC SENSING (DFOS)

(71) Applicant: NEC Laboratories America, Inc., Princeton, NJ (US)

(72) Inventors: Zhuocheng JIANG, Plainsboro, NJ (US); Yangmin DING, East Brunswick, NJ (US); Yue TIAN, Princeton, NJ (US); Sarper OZHARAR, Pennington, NJ (US); Ting WANG, West Windsor, NJ (US); Yanchao Wang, Princeton, NJ (US)

(73) Assignee: NEC Laboratories America, Inc., Princeton, NJ (US)

(21) Appl. No.: 18/901,719

(22) Filed: Sep. 30, 2024

Related U.S. Application Data
(60) Provisional application No. 63/592,692, filed on Oct. 24, 2023.

(51) Int. Cl. G01W 1/14; G01H 9/00

(52) U.S. Cl. CPC G01W 1/14; G01H 9/004

(57) ABSTRACT

Disclosed are systems, methods, and structures that provide superior DFOS rain intensity measurements and introduce a universal solution for rain intensity detection based on the data collected by distributed acoustic sensing (DAS) technology and a designed domain generalization method. As a result, systems and methods according to the present disclosure distinguish the rain intensity of a large area through which the fiber optic cables traverse and address the domain shift issue, by employing a domain generalization technique based on machine learning technology in which newly collected target domain inference data may be distributed differently from the previously captured training source domain data. To generalize the trained model to different target domains, source domain distributions are enriched by disturbing the distribution in the frequency domain. Algorithms specifically designed to transfer the noise pattern under ambient noise environments are used to further augment the source domain distributions.

### CROSS-REFERENCE TO RELATED APPLICATIONS

This application claims the benefit of U.S. Provisional Patent Application Ser. No. 63/592,692 filed Oct. 24, 2023, the entire contents of which is incorporated by reference as if set forth at length herein.

### FIELD OF THE INVENTION

This application relates generally to distributed fiber optic sensing (DFOS) systems, methods, structures, and related technologies. More particularly, it pertains to domain generalization for cross-domain rain intensity detection based on DFOS.

### BACKGROUND OF THE INVENTION

Distributed fiber optic sensing (DFOS) systems, methods, and structures have found widespread utility in contemporary industry and society. One particularly useful contemporary application of DFOS involves detecting rain intensity across different fiber routes or the same route on different dates. As is known, the rain detection performance has a significant decrease in newly collected data due to the variance of features between source data and new target data. This is a so-called “domain-shifting” issue from a machine learning perspective.

Solving the issue for a DFOS system is very important for telecommunications carriers or users to obtain real-time weather information for a large area and take quick reactions for field work planning and natural disaster prevention. Existing technologies based on transfer learning and domain adaption require a small portion of unlabeled/labeled target data for model retraining to boost the detection performance, however, these methods are computationally expensive and fail to provide real-time rain conditions.

### SUMMARY OF THE INVENTION

An advance in the art is made according to aspects of the present disclosure directed to systems, methods, and structures that provide superior DFOS rain intensity measurements.

In sharp contrast to the prior art, systems and methods according to aspects of the present disclosure introduces a universal solution for rain intensity detection based on the data collected by distributed acoustic sensing (DAS) technology and a designed domain generalization method.

Advantageously, DAS can capture acoustic signals from every location along an aerial fiber cable simultaneously. The entire aerial fiber cable is constantly vibrated by environmental noise, in our case, the vibration is aroused by the raindrops hitting the aerial fiber cable. By analysis of the vibration patterns of the DAS signals from each location, our inventive system and method according to the present disclosure can distinguish the rain intensity of a large area through which the fiber optic cables traverse.

As we shall show and describe, to address the domain shift issue, systems and methods according to the present disclosure employ a domain generalization technique based on machine learning technology. Due to the variation of environmental noise such as wind, nearby traffic, and human activities, newly collected target domain inference data may be distributed differently from the previously captured training source domain data. To generalize the trained model to different target domains, we enrich the source domain distributions by disturbing the distribution in the frequency domain. Algorithms specifically designed to transfer the noise pattern under ambient noise environments are used to further augment the source domain distributions.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic flow diagram showing an illustrative overall method according to aspects of the present disclosure.

FIG. 3 is a schematic diagram showing an illustrative DAS operation and system according to aspects of the present disclosure.

FIG. 4 is a schematic block feature diagram showing some illustrative features of systems, methods, and structures according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

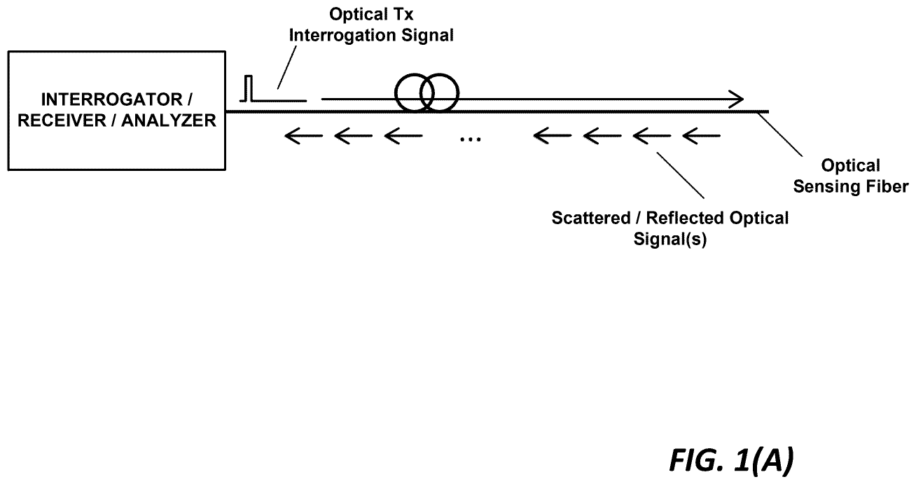

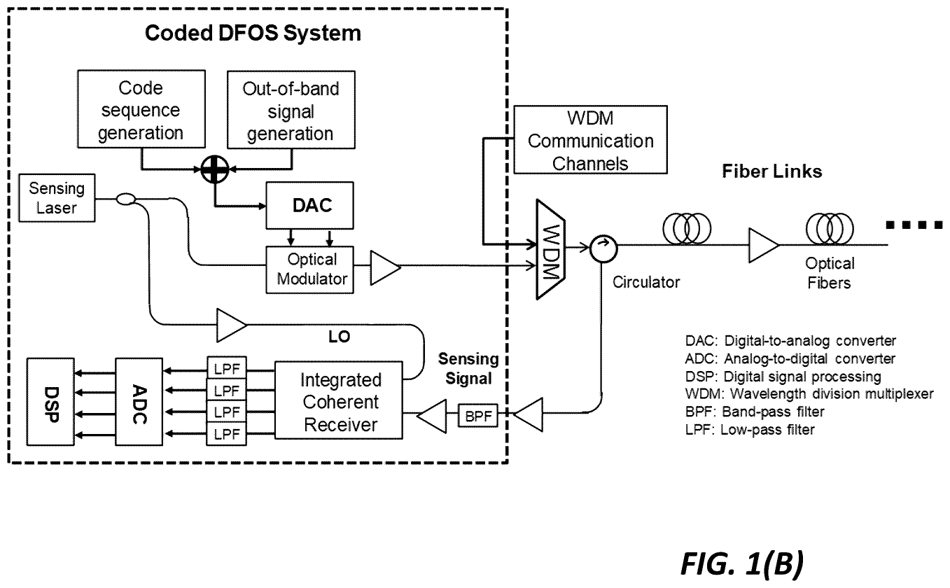

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates-for example-a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Of particular interest, distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DVS allows for continuous monitoring over long distances, but instead of measuring temperature, it measures vibrations and sounds along the fiber.

DVS operates as follows.

Light pulses are sent through the fiber optic sensor cable.

As the light travels through the cable, vibrations and sounds cause the fiber to stretch and contract slightly.

These tiny changes in the fiber's length affect how the light interacts with the material, causing a shift in the backscattered light's frequency.

By analyzing the frequency shift of the backscattered light, the DAS/DVS system can determine the location and intensity of the vibrations or sounds along the fiber optic cable.

Similar to DTS, DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technology has a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As the technology continues to develop, DAS/DVS is expected to become even more widely used in various fields where continuous and sensitive acoustic/vibration monitoring is crucial.

With the above in mind, we once again note that systems and methods according to the present disclosure introduce a universal solution for rain intensity detection based on the data collected by distributed acoustic sensing (DAS) technology and our domain generalization method.

As is known, DAS can capture acoustic signals from every location along the length of an aerial fiber cable simultaneously. Since the whole aerial fiber cable is constantly vibrated by environmental noise, the vibrations are aroused by the raindrops hitting the aerial fiber cables. By analysis of the vibration patterns of the DAS signals from each location, our systems and methods according to the present disclosure can distinguish the rain intensity of a large area covered by fiber cables.

To address the domain shift issue previously noted, we employ a novel domain generalization method based on machine learning technology. Due to the variation of environmental noise such as wind, nearby traffic, and human activities, newly collected target domain inference data may be distributed differently from the previously captured training source domain data.

To generalize the trained model to different target domains, we enrich the source domain distributions by disturbing the distribution in the frequency domain. Besides, we also design algorithms to transfer the noise pattern under ambient noise environments to further augment the source domain distributions.

According to aspects of the present disclosure, DAS technology is used to simultaneously collect raindrop vibration signals from every individual location on the aerial cables. The collected data are separated into a source domain and a target domain for model training and inference. We now describe herein a universal solution for all target data collected on different fiber routes or on different dates, without requiring any target data to adopt or transfer the features. As a result, our inventive systems and methods significantly reduce computational time and achieve real-time weather detection. Additionally, a source domain augmentation method is described which enriches source data by disturbing the frequency distribution. Finally, ambient features from a normal environment are extracted and transferred to rain source domains.

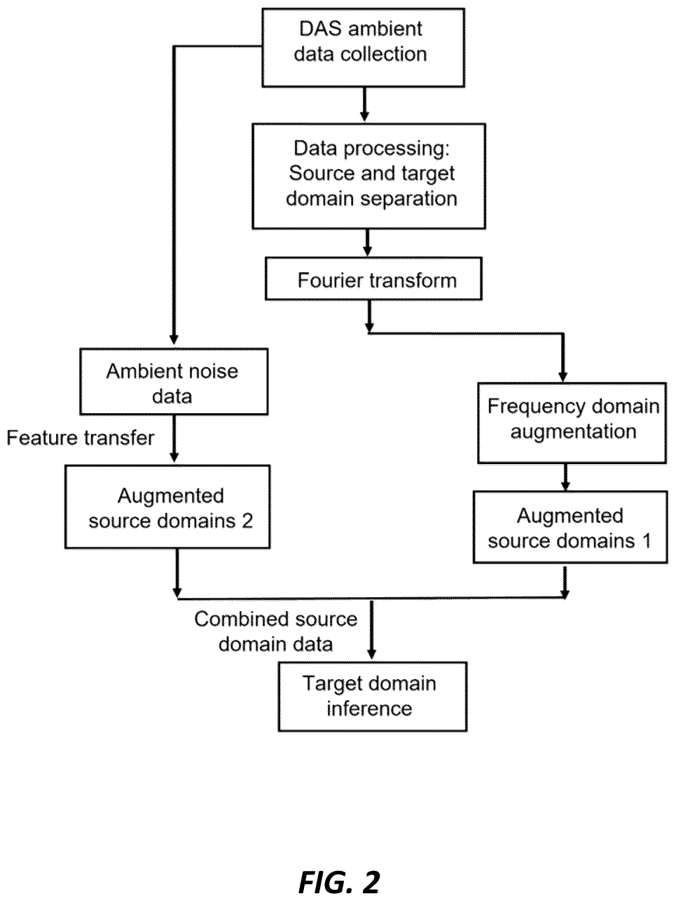

FIG. 2 is a schematic flow diagram showing an illustrative overall method according to aspects of the present disclosure.

With reference to this FIG. 2, we note that based on the basic knowledge that the acoustic vibration patterns captured at different rain intensities (normal, light rain, moderate rain, heavy rain) might be represented differently, we developed a machine learning framework to distinguish those four vibration patterns.

For data collection, a DAS can monitor acoustic vibrations with meter-scale spatial resolution in real time. A preprocessing step that separates the original DAS data into source domain and target domain according to the fiber routes and collection dates. A domain generalization method based on domain augmentation and ambient feature transfer is proposed to improve the accuracy of the trained model on the target domain. Note no additional unlabeled or labeled target domain data is required to fine-turning the training model.

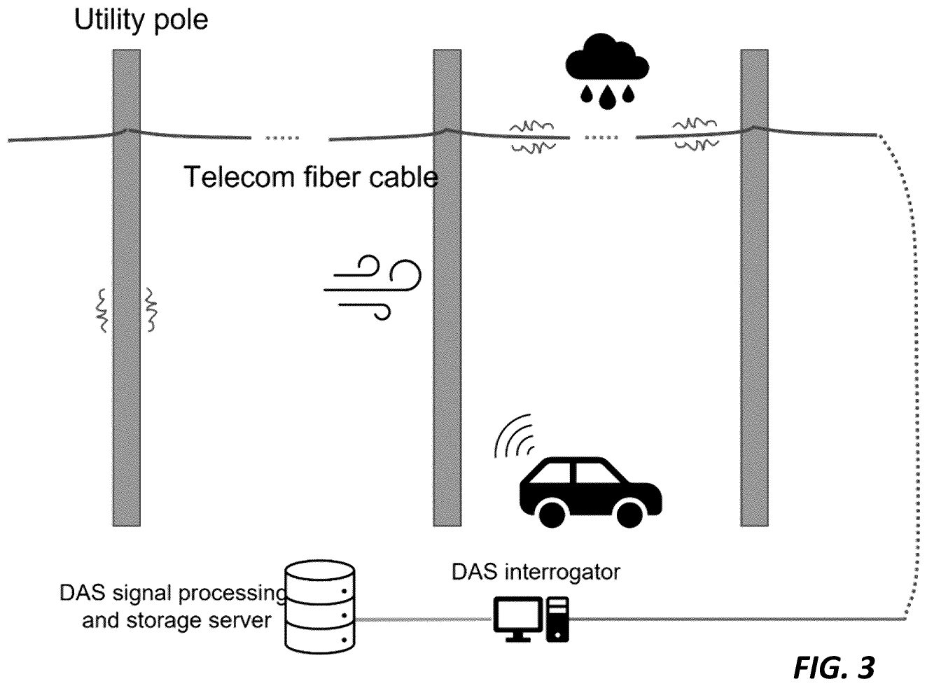

FIG. 3 is a schematic diagram showing an illustrative DAS operation and system according to aspects of the present disclosure.

The implementation details are generally implemented as follows.

### Data Collection and Labeling

A DAS system located at one end of the fiber can capture real-time raindrop acoustic

vibrations along tens of kilometers of fiber optic cables with meter-scale spatial resolution. Operationally, recorded raw data are collected from different fiber routes and different dates, which represent different domains due to changing ambient environment(s). In our case, the raw data is labeled into four categories: ambient, light rain, moderate rain, and heavy rain.

### Data Preprocessing

Pre-processing is performed and includes separating raw data into source domain and target domain according to fiber route and collection date. Then, the source domain data are further partitioned into training, validation, and testing sets. Note that the source domain data is used for model training and target domain data for model inference only.

### Domain Augmentation

The preprocessed data is transferred into the frequency domain. By disturbing the underlining distribution of the source domain, we augment the source domain distributions to enrich the training data samples. Meanwhile, the ambient data features are extracted and transferred to the existing source domain to enlarge the source distributions.

### Domain Generalization

With the pre-trained model ready, the target domain data from different fiber routes or different collection dates can be fed into the model without any additional fine-tuning. With enlarged source domain distributions, the trained model improves the performance when encountering out-of-distribution data in the target domain.

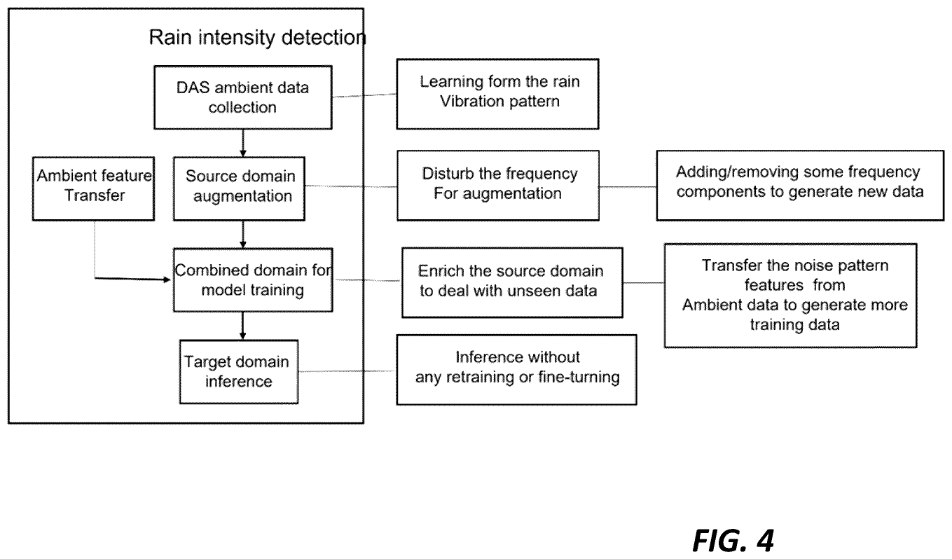

FIG. 4 is a schematic block feature diagram showing some illustrative features of systems, methods, and structures according to aspects of the present disclosure.

While we have presented our inventive concepts and description using specific examples, our invention is not so limited. Accordingly, the scope of our invention should be considered in view of the following claims.

1. A method for cross-domain rain intensity detection based on distributed fiber optic sensing (DFOS), the method comprising:
separating, collected raindrop vibration data into a source domain data and a target domain data;
further partitioning, the target domain data into training, validation and testing sets;
augmenting the source domain data by first transforming the source domain data into a frequency domain; and
generating a target domain inference and outputting a result of the inference.

2. The method of claim 1 wherein the raindrop vibration data is captured by DFOS from different fiber routes and dates, which represent different domains.

3. The method of claim 2 wherein the raindrop vibration data captured by DFOS is labeled into four categories including ambient, light rain, moderate rain, and heavy rain.

4. The method of claim 3 wherein the separating of the raindrop vibration data is performed according to fiber route and collection date.

5. The method of claim 4 wherein the domain augmenting includes disturbing underlying distribution of the source domain distribution, extracting ambient data features, and transferring the extracted ambient data features to the source domain such that a source distribution is enlarged.
